(19) United States
(12) Patent Application Publication
(10) Pub. No.: US 2013/0042712 A1
(43) Pub. Date: Feb. 21, 2013

(54) GEAR MECHANISM

(71) Applicants: Seiji Hiroshima, Okazaki-shi (JP); Shinjiro Kuze, Toyota-shi (JP); Makoto Takahashi, Toyota-shi (JP); Naoki Hanada, Kariya-shi (JP)

(72) Inventors: Seiji Hiroshima, Okazaki-shi (JP); Shinjiro Kuze, Toyota-shi (JP); Makoto Takahashi, Toyota-shi (JP); Naoki Hanada, Kariya-shi (JP)

(73) Assignee: TOYOTA JIDOSHA KABUSHIKI KAISHA, Toyota-shi (JP)

(21) Appl. No.: 13/637,542

(22) PCT Filed: May 2, 2011
(86) PCT No.: PCT/IB11/00937

§ 371 Date: Sep. 26, 2012

(30) Foreign Application Priority Data
May 11, 2010 (JP) 2010-109372

(51) Int. Cl. F16H 1/04

(52) U.S. Cl. 74/421 R

(57) ABSTRACT

A decelerating-side tooth surface of each tooth of a drive gear contacts a corresponding one of teeth of a driven gear to transmit torque when torque transmitted between the drive gear and the driven gear is maximum, and is formed as follows. The decelerating-side tooth surface protrudes toward the corresponding tooth of the driven gear and has a circular arc curvature to a facewidth direction of the corresponding tooth. The decelerating-side tooth surface is formed so that a center of the circular arc curvature is located apart in a facewidth direction of the tooth of the drive gear from a plane perpendicular to the facewidth direction in a middle in the facewidth direction toward an opposite side from a portion of the decelerating-side tooth surface that contacts the corresponding tooth of the driven gear at the time when the transmitted torque is maximum.

### BACKGROUND OF THE INVENTION

1. Field of the Invention

The invention relates to a gear mechanism.

2. Description of the Related Art

Japanese Patent Application Publication No. 2008-202664 (JP-A-2008-202664) describes a gear mechanism. The gear mechanism includes a first gear and a second gear that are in mesh with each other so as to transmit torque. In the gear mechanism, each pair of teeth at the meshed portions of the first and second gears contact each other so as to extend parallel to each other in the facewidth direction of those teeth.

Here, as shown in FIG. 18, a decelerating-side tooth surface 81a is formed on one side of each tooth 81 of the first gear in the rotation direction (direction from the upper side toward the lower side in the drawing) of the first gear. The decelerating-side tooth surface 81a contacts a corresponding one of teeth 82 of the second gear during deceleration to transmit the torque. Then, during deceleration, torque is transmitted between the meshed first and second gears via the decelerating-side tooth surface 81a. On the other hand, an accelerating-side tooth surface 81b is formed on an opposite side of each tooth 81 of the first gear, other than the above one side, in the rotation direction of the first gear. The accelerating-side gear surface 81b contacts a corresponding one of the teeth 82 of the second gear during acceleration to transmit the torque. Then, during acceleration, torque is transmitted between the meshed first and second gears via the accelerating-side tooth surface 81b as shown in FIG. 19.

Incidentally, depending on the usage of the gear mechanism, torque transmitted between the meshed first and second gears becomes excessive, and, therefore, a shaft fixed to the first gear, a shaft fixed to the second gear and support portions (a case of the gear mechanism, or the like) that support those shafts may elastically deform. As the shafts and the support portions elastically deform in this way, the relative position between the teeth of the first gear and the teeth of the second gear varies from an appropriate state, and, as a result, it is difficult to maintain a pair of teeth 81 and 82 that contact each other at the meshed portions of the first and second gears so as to extend parallel to each other in the facewidth direction of the pair of teeth 81 and 82. In other words, it is highly likely that a pair of teeth 81 and 82 that contact each other at the meshed portions of the first and second gears are not parallel to each other unlike the above described relative position but a pair of teeth 81 and 82 contact each other so as to be inclined at, for example, an inclination angle θ with respect to each other as shown in FIG. 20.

Then, as a pair of teeth 81 and 82 contact each other at the meshed portions of the first and second gears so as to be inclined with respect to each other, there occurs partial contact between the pair of teeth 81 and 82, that is, the pair of teeth 81 and 82 contact each other only at respective end portions in the facewidth direction. When the partial contact between a pair of teeth 81 and 82 occurs, because the contact area between the pair of teeth 81 and 82 reduces, a load concentrates on the contact portions of the pair of teeth 81 and 82 when torque is transmitted between the first and second gears. In addition, because of the load concentration, tooth surfaces (in this example, the decelerating-side tooth surface 81a and a tooth surface of a corresponding one of the teeth 82, which contacts the decelerating-side tooth surface 81a) may plastically deform or the durability of the pair of teeth 81 and 82 may deteriorate.

Therefore, as measures against the above problem that arises when torque transmitted between the first gear and the second gear excessively increases, it is conceivable that the tooth surface of each tooth 81 of the first gear (in this example, the decelerating-side tooth surface 81a) is formed as shown in FIG. 21. Note that the relative position between the tooth 81 of the first gear and the tooth 82 of the second gear in the drawing shows a position when torque transmitted between the first gear and the second gear is a normal value (a value within a torque range in normal use). The decelerating-side tooth surface 81a in the drawing is formed so that an inclination (inclination of “−θ” in the drawing) that can absorb an inclination of the inclined angle θ at the time when the torque is excessively large is formed between the decelerating-side tooth surface 81a and the tooth surface of the adjacent tooth 82.

When the tooth surface of each tooth 81 of the first gear is formed in this way, a pair of teeth 81 and 82 contact with a large contact area as shown in FIG. 22 when torque transmitted between the first gear and the second gear is excessively large and, therefore, the pair of teeth 81 and 82 that contact each other at the meshed portions of the first and second gears are inclined at the inclination angle θ with respect to each other. As a result, partial contact between a pair of teeth 81 and 82, that is, a pair of teeth 81 and 82 contact each other only at the respective end portions in the facewidth direction is prevented, and, by extension, plastic deformation of the tooth surfaces of the pair of teeth 81 and 82 and deterioration in the durability of the pair of teeth 81 and 82 due to load concentration on the contact portions between the pair of teeth 81 and 82 resulting from the partial contact are prevented.

The tooth surface of each tooth 81 of the first gear is fanned so as to be inclined in advance as shown in FIG. 21. By so doing, when torque transmitted between the first gear and the second gear becomes excessively large, partial contact between a pair of teeth 1 and 82 and load concentration on the contact portions of the pair of teeth 81 and 82 resulting from the partial contact may be prevented.

However, when torque transmitted between the first gear and the second gear is a normal value, partial contact between a pair of teeth 81 and 82 cannot be avoided because of the inclined tooth surface of each tooth 81. While torque transmitted between the first gear and the second gear is a normal value in this way, when partial contact between a pair of teeth 81 and 82 occurs and, therefore, the contact length in the facewidth direction between the pair of teeth 81 and 82 excessively reduces, noise is generated when torque is transmitted between the meshed first and second gears.

Such noise is presumed to be generated because of a period of time during which there is no contact between a pair of teeth 81 and 82 during rotation of the first and second gears as the contact length in the facewidth direction between the pair of teeth 81 and 82 reduces. That is, when there occurs a period of time during which there is no contact between a pair of teeth 81 and 82, the non-contact period of time and the contact period of time alternately come. Therefore, it is presumable that torque transmitted between the first gear and the second gear fluctuates and then such fluctuations in torque cause the noise to arise.

Note that JP-A-2008-202664 describes a technique for varying at least one of the shapes, specifically, angle of pressure, angle of twist, tooth profile roundness and crowning, of the tooth surfaces of the meshed gears from each other so as not to cause noise to arise when the gears are in mesh with each other. When the above technique is applied to the gear mechanism, it may be possible to suppress generation of noise when torque transmitted between the first gear and the second gear is a normal value; however, it is unlikely that the shape of the tooth surface of each tooth 81 of the first gear becomes the shape shown in FIG. 21. Therefore, when torque transmitted between the first gear and the second gear becomes excessively large, it is highly likely that partial contact between a pair of teeth 81 and 82 and load concentration on the contact portions of the pair of teeth 81 and 82 resulting from the partial contact cannot be prevented.

### SUMMARY OF INVENTION

The invention provides a gear mechanism that is able to suppress noise when torque transmitted between a first gear and a second gear is a normal value and is also able to suppress load concentration on contact portions of a pair of teeth of the first and second gears when the torque is excessively large.

An aspect of the invention relates to a gear mechanism. In the gear mechanism, a decelerating-side tooth surface formed on one side of each tooth of a first gear in a rotation direction of the first gear contacts a corresponding one of teeth of a second gear to transmit torque during deceleration. That is, during deceleration, torque is transmitted between the first gear and the second gear via the decelerating-side tooth surface. In addition, an accelerating-side tooth surface formed on an opposite side of each tooth of the first gear, other than the one side, in the rotation direction of the first gear contacts a corresponding one of the teeth of the second gear to transmit torque during acceleration. That is, during acceleration, torque is transmitted between the first gear and the second gear via the accelerating-side tooth surface. Then, one of the decelerating-side tooth surface and accelerating-side tooth surface of each tooth of the first gear protrudes toward the corresponding one of the teeth of the second gear and has a circular arc curvature with respect to a facewidth direction of the corresponding one of the teeth of the second gear. Furthermore, the circular arc tooth surface is formed so that a center of the circular arc curvature is located apart in a facewidth direction of the tooth of the first gear from a plane perpendicular to the facewidth direction of the tooth of the first gear in a middle of the tooth of the first gear in the facewidth direction.

By forming the circular arc tooth surface for the first gear, one of the decelerating-side tooth surface and accelerating-side tooth surface of each tooth of the first gear, which contacts the corresponding one of the teeth of the second gear to transmit torque when torque transmitted between the first gear and the second gear is maximum, may protrude toward the corresponding one of the teeth of the second gear and may have a circular arc curvature with respect to the facewidth direction of the tooth of the second gear. Furthermore, the circular arc tooth surface may be formed so that a center of the circular arc curvature is located apart in a facewidth direction of the tooth of the first gear from a plane perpendicular to the facewidth direction of the tooth of the first gear in a middle of the tooth of the first gear in the facewidth direction toward an opposite side from a portion of the above tooth surface that contacts the corresponding one of the teeth of the second gear at the time when the transmitted torque is maximum.

Here, when torque transmitted between the meshed first gear and second gear is a normal value and the circular arc tooth surface of each tooth of the first gear contacts the tooth surface of the corresponding one of the teeth of the second gear, the pair of teeth of those tooth surfaces do not partially contact each other only at end portions in the facewidth direction. In addition, the above partial contact between a pair of teeth does not excessively reduce the contact length in the facewidth direction between the pair of teeth. This is because, owing to the circular arc tooth surface of each tooth of the first gear, the pair of teeth do not contact each other at the end portions in the facewidth direction and the contact length in the facewidth direction between the pair of teeth is ensured through elastic deformation of contact portions of the pair of teeth at the time when torque is transmitted. Thus, when torque transmitted between the meshed first gear and second gear is a normal value, and when the circular arc tooth surface of each tooth of the first gear contacts the tooth surface of the corresponding one of the teeth of the second gear, it is possible to suppress excessive reduction in the contact length in the facewidth direction between a pair of teeth because of partial contact between the pair of teeth having those tooth surfaces only at the end portions in the facewidth direction. In addition, it is possible to suppress noise due to the reduction in the contact length in the facewidth direction between the pair of teeth.

On the other hand, when torque transmitted between the meshed first gear and second gear is excessively large (for example, maximum) and, therefore, a shaft fixed to the first gear, a shaft fixed to the second gear and support portions that support those shafts elastically deform, a pair of teeth that contact each other at the meshed portions of the first gear and second gear are inclined with respect to each other accordingly. When a pair of teeth are inclined with respect to each other in this way, the pair of teeth contact each other at a location adjacent to opposite end portions opposite from the above in the facewidth direction; however, reduction in the contact area between the pair of teeth is suppressed during then. This is because one of the decelerating-side tooth surface and accelerating-side tooth surface of each tooth of the first gear, which contacts the corresponding one of the teeth of the second gear to transmit torque when torque transmitted between the first gear and the second gear is maximum, is formed in a circular arc shape as described above to elongate the contact length in the facewidth direction between the pair of teeth that contact at the location adjacent to the end portions in the facewidth direction to thereby make it possible to increase the contact area between the pair of teeth. That is, in a state where the circular arc tooth surface is formed on each tooth of the first gear and a center of the circular arc shape is located as described above, when the contact portions of a pair of teeth elastically deform at the time when the torque is transmitted, the pair of teeth contact each other over a long length in the facewidth direction, so the contact area between the pair of teeth increases. Thus, in a state where torque transmitted between the meshed first gear and second gear is excessively large, even when a pair of teeth at the meshed portions of the first gear and second gear contact each other at the location adjacent to the end portions, the contact area between the pair of teeth at the time of the contact may be increased, so it is possible to suppress load concentration on the contact portions of the pair of teeth.

As described above, it is possible to suppress noise when torque transmitted between the first gear and the second gear is a normal value and is also possible to suppress load concentration on the contact portions of a pair of teeth in the respective gears when the torque is excessively large.

Note that the curvature radius of the circular arc of the circular arc tooth surface of each tooth of the first gear and the center position of the circular arc may be, for example, set as follows. That is, when torque transmitted between the meshed first gear and second gear is a normal value and the circular arc tooth surface of each tooth of the first gear contacts the tooth surface of the corresponding one of the teeth of the second gear, the curvature radius and the center position may be set so that the contact length in the facewidth direction between those teeth becomes a length such that noise can be suppressed. In addition, when torque transmitted between the meshed first gear and second gear is excessively large (for example, maximum value), and when the circular arc tooth surface of each tooth of the first gear contacts the tooth surface of the corresponding one of the teeth of the second gear, the curvature radius and the center position may be set so that the contact area between a pair of teeth becomes a size such that load concentration on the contact portions of the pair of teeth can be suppressed.

In addition, the tooth surfaces of the first gear and second gear may be formed through precise machining using a machining tool (machining portions).

The first gear and the second gear each may be formed in such a manner that machining portions of a machining tool used to precisely machine tooth surfaces of roughly machined teeth are engaged with the roughly machined teeth provided for a raw material for forming the first gear or the second gear and then the raw material is rotated in this state to thereby precisely machine tooth surfaces of teeth of the raw material using the machining portions of the machining tool. One of the decelerating-side tooth surface and accelerating-side tooth surface of each tooth of the first gear, having the circular arc tooth surface, may be formed in such a manner that, when the first gear is formed, an inner shape of a portion of each machining portion of the machining tool, which precisely machines the tooth surface into, a circular arc shape, is formed in a shape corresponding to the circular arc tooth surface.

In this case, one of the decelerating-side tooth surface and accelerating-side tooth surface of each tooth of the first gear, having the circular arc tooth surface, may be formed in an appropriate shape through the precise machining.

In the gear mechanism, each tooth of the second gear may have a decelerating-side tooth surface that contacts the decelerating-side tooth surface of the corresponding one of the teeth of the first gear to transmit torque and an accelerating-side tooth surface that contacts the accelerating-side tooth surface of the corresponding one of the teeth of the first gear to transmit torque. Then, one of the decelerating-side tooth surface and accelerating-side tooth surface of each tooth of the second gear, which contacts the circular arc tooth surface of the corresponding one of the teeth of the first gear to transmit torque, may protrude toward the corresponding one of the teeth of the first gear and may have a circular arc curvature with respect to the facewidth direction of the corresponding one of the teeth of the first gear. In addition, the circular arc tooth surface of each tooth of the second gear may be formed so that a center of the circular arc curvature is located apart in the facewidth direction of the tooth of the second gear from a plane perpendicular to the facewidth direction of the tooth of the second gear in a middle of the tooth of the second gear in the facewidth direction.

In this way, the circular arc tooth surface of each tooth of the second gear is formed in addition to formation of the circular arc tooth surface of the corresponding one of the teeth of the first gear that contacts the circular arc tooth surface of that tooth of the second gear. By forming the circular arc tooth surface for the second gear, one of the decelerating-side tooth surface and accelerating-side tooth surface of each tooth of the second gear, which contacts the corresponding one of the teeth of the first gear to transmit torque when torque transmitted between the first gear and the second gear is maximum, may protrude toward the corresponding one of the teeth of the first gear and may have a circular arc curvature with respect to the facewidth direction of the tooth of the first gear. In addition, the circular arc tooth surface of each tooth of the second gear may be formed so that a center of the circular arc curvature is located apart in a facewidth direction of the tooth of the second gear from a plane perpendicular to the facewidth direction of the tooth of the second gear in a middle of the tooth of the second gear in the facewidth direction toward an opposite side from a portion of the above tooth surface that contacts the corresponding one of the teeth of the first gear at the time when the transmitted torque is maximum.

Therefore, the advantageous effect of the gear mechanism according to the aspect of the invention may be obtained without excessively reducing the curvature radius of the circular arc curvature of the circular arc tooth surface of each tooth of the first gear or the curvature radius of the circular arc curvature of the circular arc tooth surface of each tooth of the second gear or placing the center of the circular arc curvature of the tooth surface at a location excessively apart in the facewidth direction of the tooth having the tooth surface from a plane perpendicular to the facewidth direction of the tooth in a middle of the tooth in the facewidth direction. Thus, it is possible to suppress excessive reduction in the curvature radius and excessive increase in distance between the center and the plane, so the extreme circular arc curvatures of the tooth surfaces of the respective teeth of the first gear and second gear are suppressed in terms of the curvature radii or the locations of the centers of the curvatures.

A contact length between each tooth of the first gear and a corresponding one of the teeth of the second gear may be set to length such that noise due to contact between each pair of teeth can be appropriately suppressed when torque transmitted between the first gear and the second gear is a normal value.

A contact area between each tooth of the first gear and a corresponding one of the teeth of the second gear may be set to a size such that load concentration on contact portions of each pair of teeth can be appropriately suppressed when torque transmitted between the first gear and the second gear is a maximum value.

In addition, the tooth surfaces of the first gear and second gear may be formed through precise machining using a machining tool (machining portions).

The first gear and the second gear each may be formed in such a manner that machining portions of a machining tool used to precisely machine tooth surfaces of roughly machined teeth are engaged with the roughly machined teeth provided for a raw material for forming the first gear or the second gear and then the raw material, is rotated in this state to thereby precisely machine tooth surfaces of teeth of the raw material using the machining portions of the machining tool. One of the decelerating-side tooth surface and accelerating-side tooth surface of each tooth of the first gear, having the circular arc tooth surface, may be formed in such a manner that, when the first gear is formed, an inner shape of a portion of each machining portion of the machining tool, which precisely machines the tooth surface into a circular arc shape, is formed in a shape corresponding to the circular arc tooth surface. One of the decelerating-side tooth surface and accelerating-side tooth surface of each tooth of the second gear, which contacts the corresponding one of the teeth of the first gear to transmit torque, may be formed in such a manner that, when the second gear is formed, an inner shape of a portion of each machining portion of the machining tool, which precisely machines the tooth surface of each tooth of the second gear into a circular arc shape, is formed in a shape corresponding to the circular arc tooth surface.

In this case, one of the decelerating-side tooth surface and accelerating-side tooth surface of each tooth of the first gear, having the circular arc tooth surface, and one of the decelerating-side tooth surface and accelerating-side tooth surface of each tooth of the second gear, having the circular arc tooth surface, may be formed in an appropriate shape through the precise machining. In addition, because the curvatures of those circular arc tooth surfaces do not become extreme in terms of the curvature radii or the locations of the centers of the curvatures, the inner shapes of the machining portions of the machining tool used in the precise machining also do not become extreme in terms of the curvature radii or the locations of the centers of the curvatures. Thus, it is possible to suppress an increase in the degree of difficulty in precisely machining the circular arc tooth surfaces using the machining tool.

The first gear and second gear of the gear mechanism may serve as a final reduction gear in a drive train of a vehicle equipped with a manual transmission. Here, in a vehicle equipped with a manual transmission, excessive downshift may be performed because of driver's misoperation. Then, torque transmitted between the first gear and the second gear that serve as a final reduction gear becomes maximum, and the maximum torque is an extremely large value. Therefore, if the contact area between a pair of teeth at the meshed portions of the first gear and second gear is small, load concentration easily occurs on the contact portions of the pair of teeth when excessive downshift is performed because of driver's misoperation. Thus, in order to suppress such load concentration, when the decelerating-side tooth surface, which is one of the decelerating-side tooth surface and accelerating-side tooth surface of each tooth of the first gear and which receives the maximum torque, is fowled as described above, the advantageous effect that may be obtained accordingly is remarkable.

### BRIEF DESCRIPTION OF DRAWINGS

The features, advantages, and technical and industrial significance of this invention will be described below with reference to the accompanying drawings, in which like numerals denote like elements, and wherein:

FIG. 1 is a schematic view that shows a drive train of an automobile equipped with a gear mechanism according to an embodiment;

FIG. 2 is a schematic view that shows a state where a drive gear and driven gear of the gear mechanism are in mesh with each other;

FIG. 3 is a schematic view that shows the positional relationship between a pair of teeth at meshed portions of both gears;

FIG. 4 is a schematic view that shows the positional relationship between a pair of teeth at the meshed portions of both gears;

FIG. 5 is an enlarged schematic view that shows a tooth of the drive gear;

FIG. 6 is an enlarged schematic view that shows a tooth of the driven gear;

FIG. 7 is a schematic view that shows a state where decelerating-side tooth surfaces of the drive gear and driven gear contact each other;

FIG. 8 is a schematic view that shows a state where the decelerating-side tooth surfaces of the drive gear and driven gear contact each other;

FIG. 9 is a schematic view that shows a state where the decelerating-side tooth surfaces of the drive gear and driven gear contact each other;

FIG. 10 is a schematic view that shows a state where the decelerating-side tooth surfaces of the drive gear and driven gear contact each other;

FIG. 11 is a table that shows the magnitude of noise generated as both gears mesh with each other;

FIG. 12 is a graph that shows the correlation between a location in the facewidth direction of a pair of decelerating-side tooth surfaces of both gears that contact each other and a bending stress that acts on the pair of decelerating-side tooth surfaces at that location;

FIG. 13 is a graph that shows the correlation between a location in the facewidth direction of a pair of decelerating-side tooth surfaces of both gears that contact each other and a bending stress that acts on the pair of decelerating-side tooth surfaces at that location;

FIG. 14A is a schematic view that shows a raw material used to form the drive gear and a machining tool used to precisely machine the raw material;

FIG. 14B is a schematic view that shows the shape of each machining portion of the machining tool;

FIG. 15A is a schematic view that shows a raw material used to form the driven gear and a machining tool used to precisely machine the raw material;

FIG. 15B is a schematic view that shows the shape of each machining portion of the machining tool;

FIG. 16 is a schematic view that shows each tooth of a drive gear and each tooth of a driven gear according to an alternative embodiment;

FIG. 17 is a schematic view that shows each tooth of a drive gear and each tooth of a driven gear according to an alternative embodiment;

FIG. 18 is a schematic view that shows each tooth of a first gear and each tooth of a second gear according to the related art;

FIG. 19 is a schematic view that shows each tooth of the first gear and each tooth of the second gear according to the related art;

FIG. 20 is a schematic view that shows each tooth of the first gear and each tooth of the second gear according to the related art;

FIG. 21 is a schematic view that shows each tooth of the first gear and each tooth of the second gear according to the related art; and

FIG. 22 is a schematic view that shows each tooth of the first gear and each tooth of the second gear according to the related art.

### DETAILED DESCRIPTION OF EMBODIMENTS

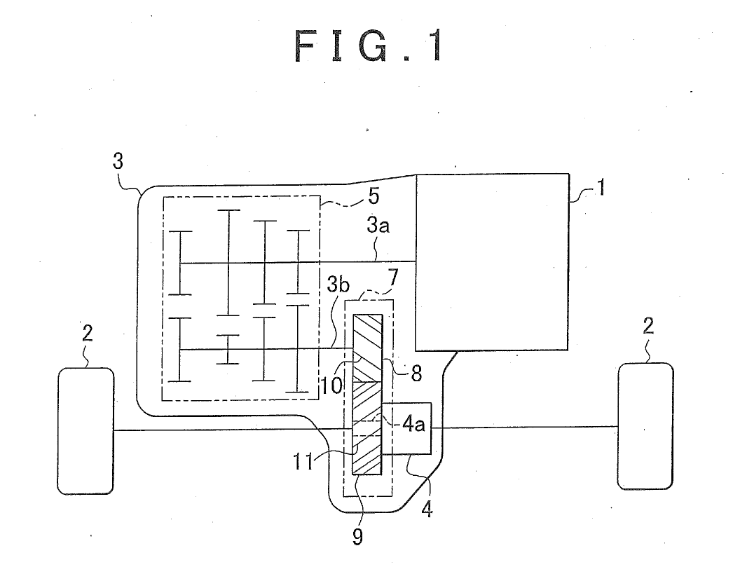

Hereinafter, a gear mechanism used to transmit torque in a drive train of an automobile according to an embodiment of the invention will be described with reference to FIG. 1 to FIG. 15B. FIG. 1 schematically shows the drive train of an automobile that drives front wheels 2 with an engine 1 mounted at the front of the body (so-called FF automobile). In this automobile, engine rotation generated by driving the engine 1 is transmitted to the front wheels 2, which are drive wheels of the automobile, via a transmission 3, a differential gear unit 4, and the like.

A manual transmission is employed as the transmission 3. The manual transmission changes the speed ratio of the automobile through driver's operation of a shift lever. The speed ratio is the ratio between the rotational speed at the side of the engine 1 and the rotational speed at the side of the front wheels 2. The transmission 3 includes an input shaft 3a, a shift mechanism 5 and an output shaft 3b. The input shaft 3a inputs engine rotation. The shift mechanism 5 is used to form a plurality of shift speeds having different speed ratios. The output shaft 3b rotates at a rotational speed that is changed from the rotational speed of the input shaft 3a at the speed ratio of the shift speed formed by the shift mechanism 5. Then, in the transmission 3, the shift speed formed by the shift mechanism 5 is changed through driver's operation of the shift lever, and the rotational speed is changed between the side of the engine 1 and the side of the front wheels 2 at the speed ratio of the shift speed formed after changing the shift speed.

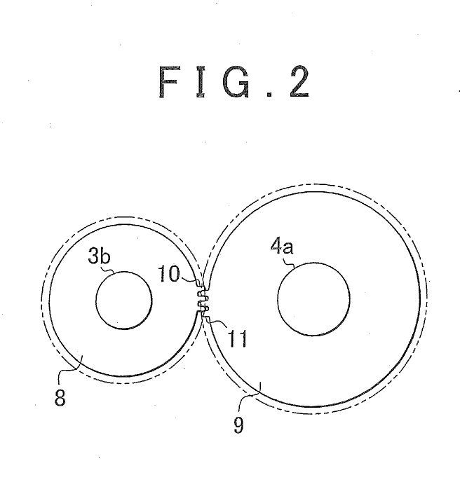

In addition, the automobile is provided with a gear mechanism 7 to transmit rotation (transmit torque) between the output shaft 3b of the transmission 3 and the differential gear unit 4. The gear mechanism 7 includes a cylindrical drive gear 8 and a cylindrical driven gear 9. The drive gear 8 is fixed to the output shaft 3b. The driven gear 9 is fixed to an input shaft 4a of the differential gear unit 4. Teeth 10 and 11 (helical teeth) are respectively formed at the outer peripheral portions of the drive gear 8 and driven gear 9 of the gear mechanism 7. The teeth 10 and 11 are inclined with respect to the central axes of the respective gears. As shown in FIG. 2, these drive gear 8 and driven gear 9 are in mesh with each other, and function as a final reduction gear in the drive train of the automobile.

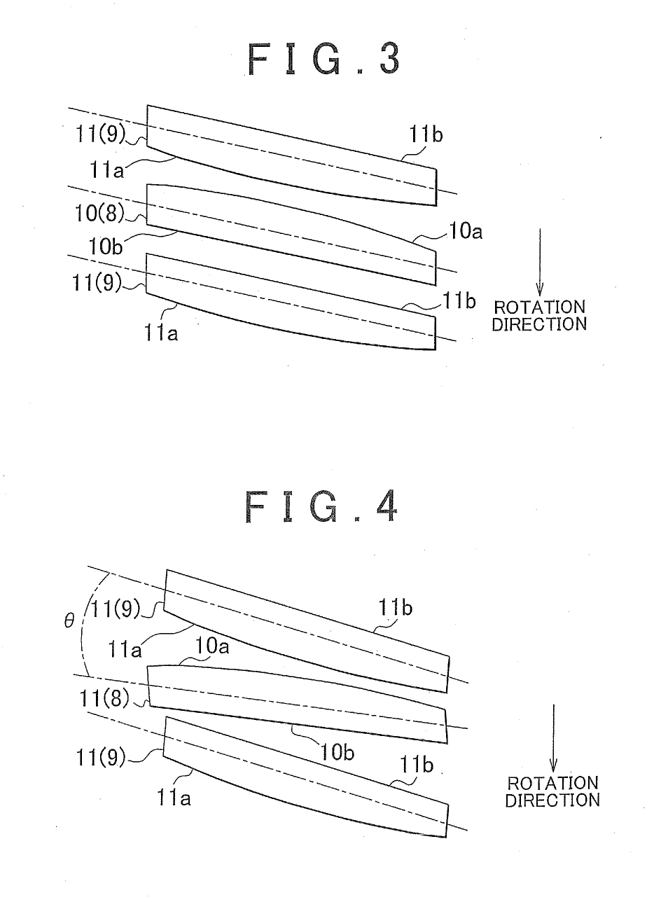

FIG. 3 schematically shows the positional relationship between a pair of teeth 10 and 11 at the meshed portions of the drive gear 8 and driven gear 9 shown in FIG. 2. As is apparent from FIG. 3, the pair of teeth 10 and 11 extend parallel to each other in the facewidth direction (direction along the alternate long and short dash line in the drawing). That is, the drive gear 8 and the driven gear 9 are provided so that a pair of teeth 10 and 11 extend parallel to each other at the meshed portions of the drive gear 8 and driven gear 9.

A decelerating-side tooth surface 10a is formed on one side (in this example, upper side in the drawing) of each tooth 10 of the drive gear 8 in the rotation direction of the drive gear 8 (direction from the upper side toward the lower side in the drawing) in FIG. 3. The decelerating-side tooth surface 10a contacts a corresponding one of the teeth 11 of the driven gear 9 to transmit torque during deceleration of the automobile. In addition, an accelerating-side tooth surface 10b is formed on an opposite side (lower side in the drawing) of each tooth 10 of the drive gear 8, other than the one side, in the rotation direction of the drive gear 8. The accelerating-side tooth surface 10b contacts a corresponding one of the teeth 11 of the driven gear 9 to transmit torque during acceleration of the automobile.

On the other hand, a decelerating-side tooth surface 11a is formed on one side (in this example, lower side in the drawing) of each tooth 11 of the driven gear 9 in the rotation direction (direction from the upper side toward the lower side in the drawing) of the driven gear 9. The decelerating-side tooth surface 11a contacts a corresponding one of the teeth 10 of the drive gear 8 to transmit torque during deceleration of the automobile. In addition, an accelerating-side tooth surface 11b is formed on an opposite side (upper side in the drawing) of each tooth 11 of the driven gear 9, other than the one side, in the rotation direction of the driven gear 9. The accelerating-side tooth surface 11b contacts a corresponding one of the teeth 10 of the drive gear 8 to transmit torque during acceleration of the automobile.

Then, during deceleration of the automobile, torque is transmitted between the drive gear 8 and the driven gear 9 via the decelerating-side tooth surfaces 10a and 11a. In addition, during acceleration of the automobile, torque is transmitted between the drive gear 8 and the driven gear 9 via the accelerating-side tooth surfaces 10b and 11b. Incidentally, depending on the operating condition of the automobile, torque transmitted between the meshed drive gear 8 and driven gear 9 becomes excessively large, and, therefore, the output shaft 3b fixed to the drive gear 8, the input shaft 4a fixed to the driven gear 9 and support portions of those output shaft 3b and input shaft 4a may elastically deform.

Here, in the automobile equipped with the manual transmission as the transmission 3, excessive downshift may be performed because of driver's misoperation. Then, torque transmitted between the drive gear 8 and the driven gear 9 that serve as a final reduction gear becomes maximum, and the maximum torque is an extremely large value. As a result, torque transmitted between the meshed drive gear 8 and driven gear 9 becomes excessively large, and, therefore, the output shaft 3b, the input shaft 4a and the support portions thereof elastically deform as described above.

Then, as the elastic deformation occurs as described above, the relative position between the teeth 10 of the drive gear 8 and the teeth 11 of the driven gear 9 varies from an appropriate state. This makes it difficult to maintain a pair of teeth 10 and 11 at the meshed portions of the drive gear 8 and driven gear 9 so as to extend parallel to each other in the facewidth direction of the pair of teeth 10 and 11. Therefore, a pair of teeth 10 and 11 that contact each other at the meshed portions of the drive gear 8 and driven gear 9 are not parallel to each other unlike the above described relative position but the pair of teeth 10 and 11 are, for example, inclined at an inclination angle θ with respect to each other as shown in FIG. 4. Then, in this state, when the pair of inclined teeth 10 and 11 contact each other at the meshed portions of the drive gear 8 and driven gear 9, there may occur partial contact between the pair of teeth 10 and 11, that is, the pair of teeth 10 and 11 contact each other only at respective end portions (properly, right end portions in the drawing) in the facewidth direction.

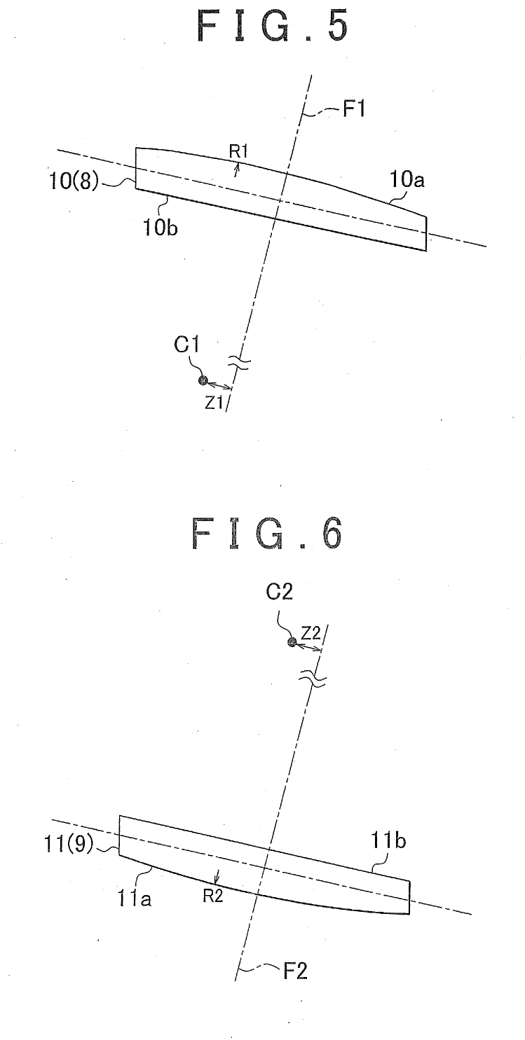

Next, the shapes of the teeth 10 and 11 will be described in detail. The decelerating-side tooth surface 10a of each tooth 10 of the drive gear 8 protrudes toward a corresponding one of the teeth 11 of the driven gear 9 and has a circular arc curvature having a curvature radius R1 in the facewidth direction of the corresponding one of the teeth 11 as shown in FIG. 5. Furthermore, the decelerating-side tooth surface 10a is formed so that the center C1 of the circular arc curvature is located at a deviation Z1 from a plane F1 perpendicular to the facewidth direction of tooth 10 of the drive gear 8 in the middle of the tooth 10 of the drive gear 8 in the facewidth direction toward an opposite side from a contact portion of the tooth surface that contacts a corresponding one of the teeth 11 of the driven gear 9 in the facewidth direction at the time when transmitted torque is maximum. The contact portion of the decelerating-side tooth surface 10a is located on the right side of the plane F1 in the drawing in this example. Therefore, the decelerating-side tooth surface 10a is formed so that the center C1 of the circular arc curvature is located on the left side of the plane F1 in the drawing.

In addition, the decelerating-side tooth surface 11a of each tooth 11 of the driven gear 9 shown in FIG. 3 protrudes toward the corresponding one of the teeth 10 of the drive gear 8 and has a circular arc curvature having a curvature radius R2 in the facewidth direction of the tooth 10 as shown in FIG. 6. Furthermore, the decelerating-side tooth surface 11a is formed so that the center C2 of the circular arc curvature is located at a deviation Z2 from a plane F2 perpendicular to the facewidth direction of the tooth 11 of the driven gear 9 in the middle of the tooth 11 of the driven gear 9 in the facewidth direction toward an opposite side from a contact portion of the tooth surface that contacts a corresponding one of the teeth 10 of the drive gear 8 in the facewidth direction at the time when transmitted torque is maximum. The contact portion of the decelerating-side tooth surface 11a is located on the right side of the plane F1 in the drawing in this example. Therefore, the decelerating-side tooth surface 11a is formed so that the center C2 of the circular arc curvature is located on the left side of the plane F2 in the drawing.

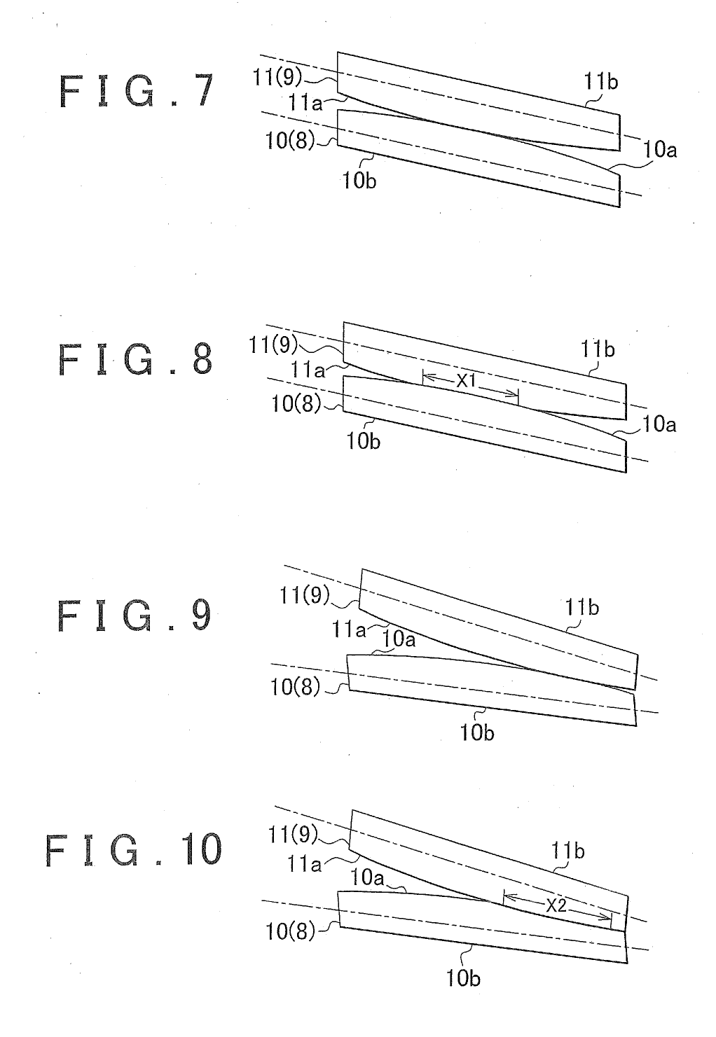

By forming the decelerating-side tooth surfaces 10a and 11a in this way, when torque transmitted between the meshed drive gear 8 and driven gear 9 is a normal value (a value within a torque range in normal use), a pair of teeth 10 and 11 do not contact each other at the meshed portions of the drive gear 8 and driven gear 9. In addition, such partial contact between a pair of teeth 10 and 11 does not excessively reduce the contact length in the facewidth direction between the pair of teeth 10 and 11. This is because, owing to the above described circular arc decelerating-side tooth surfaces 10a and 11a, a pair of teeth 10 and 11 do not contact each other at the end portions (specifically, left end portions in FIG. 5 and FIG. 6) in the facewidth direction and the contact length in the facewidth direction between a pair of teeth 10 and 11 is ensured through elastic deformation of the contact portions of the pair of teeth 10 and 11 at the time when the torque is transmitted. Specifically, when the torque is a normal value, the decelerating-side tooth surfaces 10a and 11a of the respective teeth 10 and 11 start to contact each other as shown in FIG. 7, and the contact length X1 between the pair of teeth 10 and 11 is ensured as shown in FIG. 8 through elastic deformation of the contact portions of the pair of teeth 10 and 11 immediately after the start of contact.

Thus, when torque transmitted between the meshed drive gear 8 and driven gear 9 is a normal value, it is possible to suppress excessive reduction in the contact length in the facewidth direction between a pair of teeth 10 and 11 through partial contact between the pair of teeth 10 and 11 at the meshed portions of the drive gear 8 and driven gear 9 and noise due to the reduction in the contact length. Note that the curvature radii R1 and R2 of the circular arc curvatures of each pair of decelerating-side tooth surfaces 10a and 11a and the locations (deviations Z1 and Z2) of the centers C1 and C2 of the curvatures are set so that, when torque transmitted between the drive gear 8 and the driven gear 9 is a normal value, the contact length X1 in the facewidth direction between a pair of teeth 10 and 11 becomes a length such that noise can be appropriately suppressed.

On the other hand, when torque transmitted between the meshed drive gear 8 and driven gear 9 is maximum and, therefore, the output shaft 3b, the input shaft 4a and the support portions thereof elastically deform as described above, a pair of teeth 10 and 11 that contact each other at the meshed portions of the drive gear 8 and driven gear 9 are, for example, inclined at an inclination angle θ as shown in FIG. 4. When a pair of teeth 10 and 11 are inclined with respect to each other in this way, the pair of teeth 10 and 11 contact each other at a location adjacent to the end portions (specifically, right end portions in the drawing) in the facewidth direction; however, reduction in contact area between the pair of teeth 10 and 11 is suppressed. This is because, by forming the decelerating-side tooth surfaces 10a and 11a as described above, the contact length in the facewidth direction between a pair of teeth 10 and 11 that contact each other at the location adjacent to the end portions is elongated to make it possible to increase the contact area between the pair of teeth 10 and 11. That is, in a state where the decelerating-side tooth surfaces 10a and 11a are curved in a circular arc shape and the centers C1 and C2 of the circular arc curvatures are located as described above, when the contact portions of a pair of teeth 10 and 11 elastically deform at the time when the torque is transmitted, the pair of teeth 10 and 11 contact each other over a long length in the facewidth direction, so the contact area between the pair of teeth 10 and 11 increases. Specifically, when the torque is maximum, the decelerating-side tooth surfaces 10a and 11a of the respective teeth 10 and 11 start to contact each other as shown in FIG. 9, and the contact length X2 between the pair of teeth 10 and 11 is ensured as shown in FIG. 10 through elastic deformation of the contact portions of the pair of teeth 10 and 11 immediately after the start of contact.

Thus, when torque transmitted between the meshed drive gear 8 and driven gear 9 is maximum, even when a pair of teeth 10 and 11 at the meshed portions of the drive gear 8 and driven gear 9 contact at the location adjacent to the end portions, the contact area between the pair of teeth 10 and 11 at the time of the contact may be increased. In this way, by increasing the contact area between a pair of teeth 10 and 11, it is possible to suppress load concentration on the contact portions of the pair of teeth 10 and 11. Note that the curvature radii R1 and R2 of the circular arc curvatures of each pair of decelerating-side tooth surfaces 10a and 11a and the locations (deviations Z1 and Z2) of the centers C1 and C2 of the curvatures are set so that, when torque transmitted between the drive gear 8 and the driven gear 9 is maximum, the contact area between a pair of teeth 10 and 11 becomes a size such that load concentration on the contact portions can be appropriately suppressed. Incidentally, the contact area between a pair of teeth 10 and 11 increases as the contact length X2 between the pair of teeth 10 and 11 shown in FIG. 10 increases.

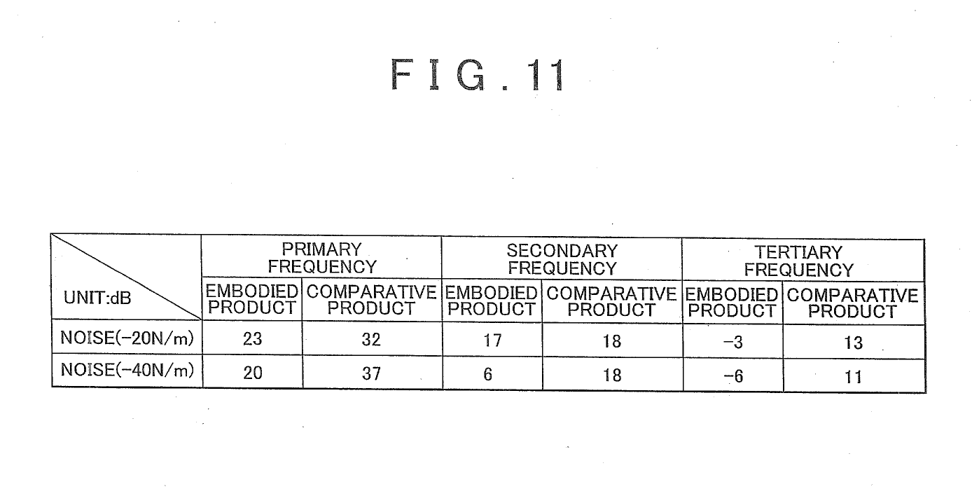

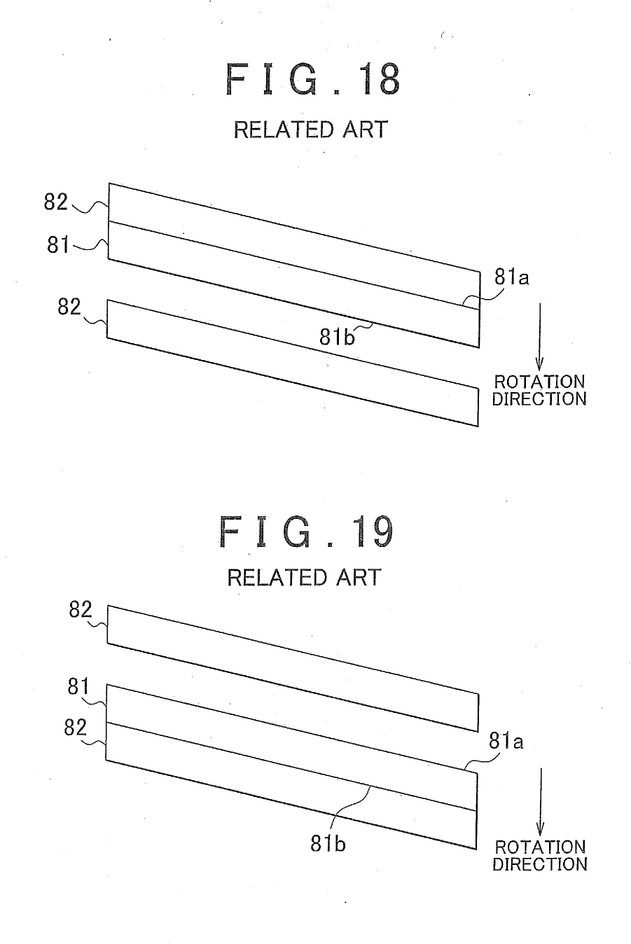

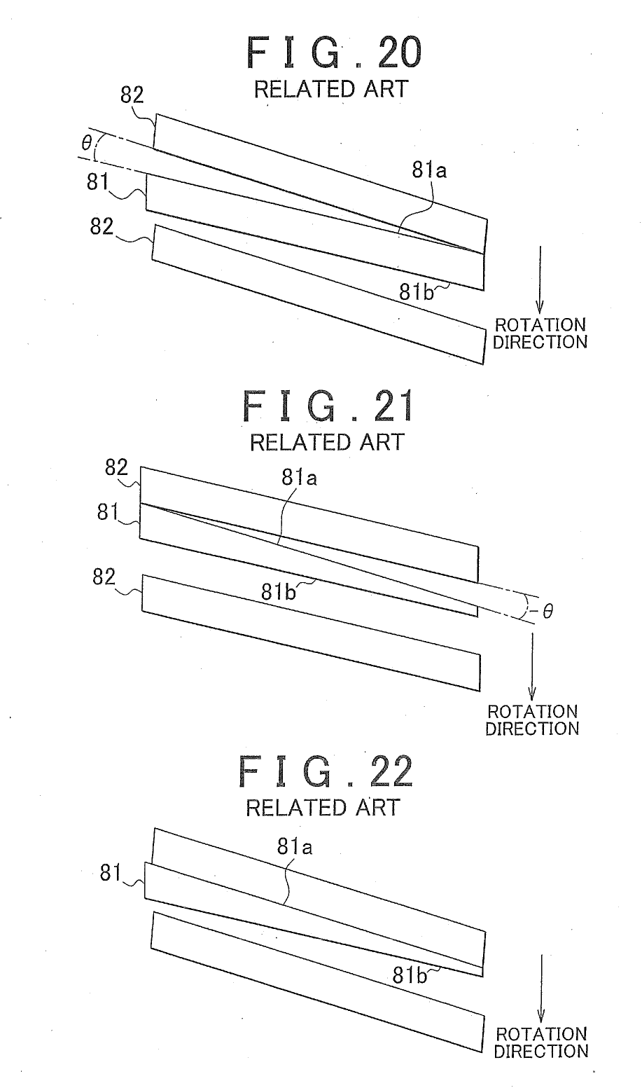

Next, the difference between the case where the decelerating-side tooth surfaces of each pair of teeth 10 and 11 are formed as in the case of the present embodiment (indicated as “embodied product” in FIG. 11) and the case where the decelerating-side tooth surfaces of each pair of teeth 10 and 11 are formed as in the case of the related art (FIG. 18) (indicated as “comparative product” in FIG. 11) will be described with reference to FIG. 11 to FIG. 13. FIG. 11 is a table that shows the magnitude of noise generated as the drive gear 8 and the driven gear 9 are meshed when torque transmitted between both gears 8 and 9 is a normal value, for example, when torque that acts on the input shaft 3a of the transmission 3 during deceleration of the engine 1 is “−20 N/m” or “−40 N/m”.

Note that, in the table of FIG. 11, the magnitude of noise is shown for each frequency, that is, primary frequency, secondary frequency and tertiary frequency. Here, the primary frequency corresponds to the number of pairs of teeth 10 and 11 that contact each other per one rotation of the drive gear 8, or the like. In addition, the secondary frequency corresponds to twice the number of pairs of teeth 10 and 11 that contact each other per one rotation of the drive gear 8, or the like. Furthermore, the tertiary frequency corresponds to three times the number of pairs of teeth 10 and 11 that contact each other per one rotation of the drive gear 8, or the like.

In the above table, both the magnitude of noise in the case where the decelerating-side tooth surfaces 10a and 11a according to the present embodiment are employed and the magnitude of noise in the case where the decelerating-side tooth surfaces according to the related art (FIG. 18) are shown for each of the magnitude of noise at the primary frequency, the magnitude of noise at the secondary frequency and the magnitude of noise at the tertiary frequency. As is apparent from the table, for noise at any frequency, the magnitude of noise in the case where the decelerating-side tooth surfaces 10a and 11a according to the present embodiment are employed is smaller than the magnitude of noise in the case where the decelerating-side tooth surfaces according to the related art are employed.

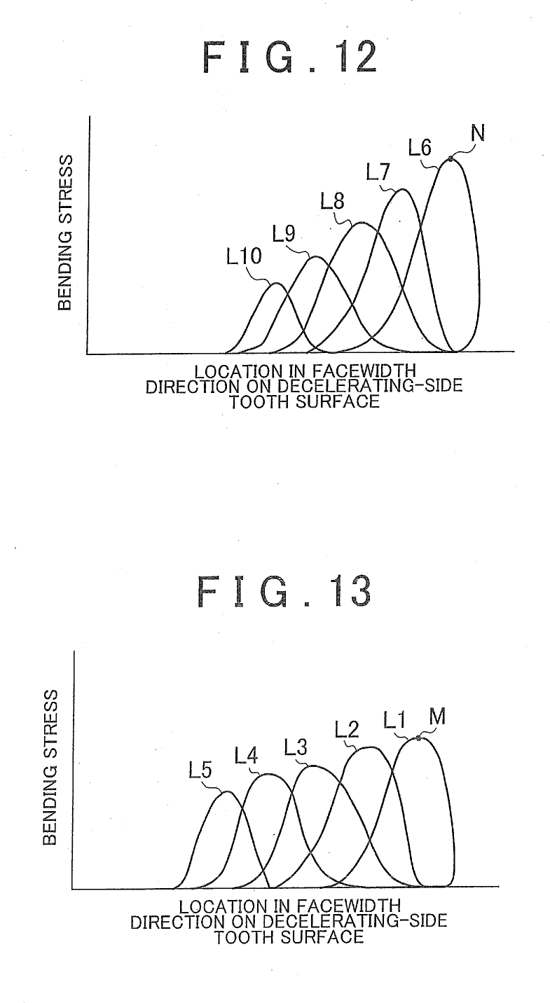

FIG. 12 and FIG. 13 are graphs that show a bending stress that acts on a pair of teeth 10 and 11 at the contact portions (decelerating-side tooth surfaces) of the pair of teeth 10 and 11 at the meshed portions of both gears 8 and 9 when excessive downshift is performed because of driver's misoperation and, by so doing, torque transmitted between the drive gear 8 and the driven gear 9 that serve as the final reduction gear is maximum. Note that, in the graphs of FIG. 12 and FIG. 13, the abscissa axis represents a location in the facewidth direction on a pair of decelerating-side tooth surfaces and the ordinate axis represents a bending stress.

In FIG. 12, the solid line L6 shows the correlation between a location in the facewidth direction on a pair of decelerating-side tooth surfaces immediately after the pair of decelerating-side tooth surfaces contact each other and a bending stress that acts on the pair of decelerating-side tooth surfaces at that location in the case where the decelerating-side tooth surfaces according to the related art (FIG. 18) are employed. The solid line that shows the above correlation sequentially varies in order of L6, L7, L8, L9 and L10 with a lapse of time from when a pair of decelerating-side tooth surfaces start to contact each other. Note that the bending stress that acts on a pair of decelerating-side tooth surfaces becomes a maximum value N immediately after the pair of decelerating-side tooth surfaces start to contact each other (corresponding to the solid line L6).

In FIG. 13, the solid line L1 shows the correlation between a location in the facewidth direction on a pair of decelerating-side tooth surfaces 10a and 11a immediately after the pair of decelerating-side tooth surfaces 10a and 11a according to the present embodiment start to contact each other and a bending stress that acts on the pair of decelerating-side tooth surfaces 10a and 11a (teeth 10 and 11) at that location. The solid line that shows the above correlation sequentially varies in order of L1, L2, L3, L4 and L5 with a lapse of time from when a pair of decelerating-side tooth surfaces 10a and 11a start to contact each other. Note that the bending stress that acts on a pair of decelerating-side tooth surfaces 10a and 11a (teeth 10 and 11) becomes a maximum value M immediately after the pair of decelerating-side tooth surfaces 10a and 11a start to contact each other. The maximum value M is smaller than the maximum value N shown in FIG. 12.

As is apparent from these graphs, the maximum value M of the bending stress in the case where the decelerating-side tooth surfaces 10a and 11a according to the present embodiment are employed is smaller than the maximum value N of the bending stress in the case where the decelerating-side tooth surfaces according to the related art are employed. This means that, when torque transmitted between the drive gear 8 and the driven gear 9 is maximum, load concentration on the contact portions (decelerating-side tooth surfaces 10a and 11a) of each pair of teeth 10 and 11 is adequately suppressed.

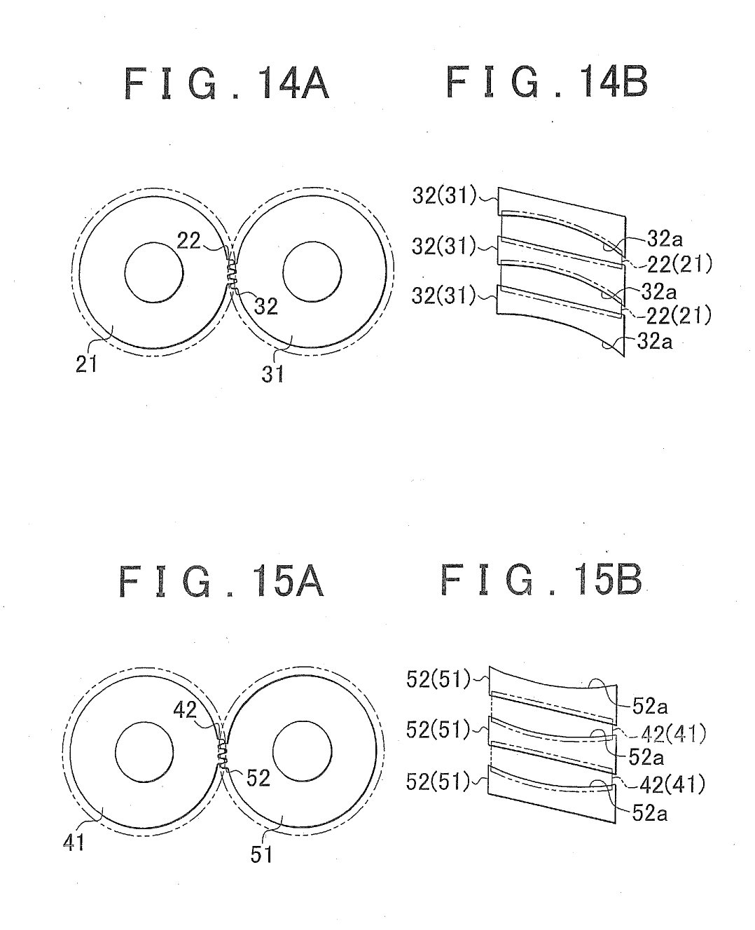

Next, a method of forming the teeth 10 and 11 of the respective drive gear 8 and driven gear 9 will be described with reference to FIG. 14A to FIG. 15B. FIG. 14A schematically shows a raw material 21 used to form the drive gear 8 and a machining tool 31 that includes machining portions 32 used to precisely machine the tooth surfaces of roughly machined teeth 22 provided for the raw material 21. The drive gear 8 is formed in such a manner that the machining portions 32 of the machining tool 31 are engaged with the roughly machined teeth 22 provided for the raw material 21 and then the raw material 21 is rotated in this state to thereby precisely machine the tooth surfaces of the teeth 22 of the raw material 21 using the machining portions 32 of the machining tool 31. Through the above precise machining, the decelerating-side tooth surface 10a and accelerating-side tooth surface 10b (both are shown in FIG. 3) of each tooth 10 of the drive gear 8 are formed. Note that the decelerating-side tooth surfaces 10a are formed through the precise machining in such a manner that, during formation of the drive gear 8, an inner surface 32a of each machining portion 32 of the machining tool 31 used to precisely machine the decelerating-side tooth surface 10a as shown in FIG. 14B has an inner shape corresponding to the decelerating-side tooth surface 10a. Incidentally, a specific example of the precise machining through the above procedure may be shaving, honing or rolling.

FIG. 15A schematically shows a raw material 41 used to form the driven gear 9 and a machining tool 51 that includes machining portions 52 used to precisely machine the tooth surfaces of roughly machined teeth 42 provided for the raw material 41. The driven gear 9 is fowled in such a manner that the machining portions 52 of the machining tool 51 are engaged with the roughly machined teeth 42 provided for the raw material 41 and then the raw material 41 is rotated in this state to thereby precisely machine the tooth surfaces of the teeth 42 of the raw material 41 using the machining portions 52 of the machining tool 51. Through the above precise machining, the decelerating-side tooth surface 11a and accelerating-side tooth surface 11b (both are shown in FIG. 3) of each tooth 11 of the driven gear 9 are formed. Note that the decelerating-side tooth surfaces 11a are formed through the precise machining in such a mariner that, during formation of the driven gear 9, an inner surface 52a of each machining portion 52 of the machining tool 51 used to precisely machine the decelerating-side tooth surface 11a as shown in FIG. 15B has an inner shape corresponding to the decelerating-side tooth surface 11a. Incidentally, a specific example of the precise machining through the above procedure may be shaving, honing or rolling.

According to the above described embodiment, the following advantageous effects may be obtained.

(1) The decelerating-side tooth surface 10a of each tooth 10 of the drive gear 8 contacts a corresponding one of the teeth 11 of the driven gear 9 when torque transmitted between the drive gear 8 and the driven gear 9 is maximum to thereby transmit the torque. The decelerating-side tooth surface 10a is formed as follows. That is, the decelerating-side tooth surface 10a protrudes toward a corresponding one of the teeth 11 of the driven gear 9 and has a circular arc curvature having a curvature radius R1 in the facewidth direction of the corresponding one of the teeth 11. Furthermore, the decelerating-side tooth surface 10a is formed so that the center C1 of the circular arc curvature is located at a deviation Z1 from a plane F1 perpendicular to the facewidth direction of the tooth 10 of the drive gear 8 in the middle of the tooth 10 of the drive gear 8 in the facewidth direction toward an opposite side from a portion of the decelerating-side tooth surface 10a that contacts a corresponding one of the teeth 11 of the driven gear 9 in the facewidth direction at the time when the transmitted torque is maximum.

In addition, the decelerating-side tooth surface 11a of each tooth 11 of the driven gear 9 contacts a corresponding one of the teeth 11 of the driven gear 9 when torque transmitted between the drive gear 8 and the driven gear 9 is maximum to thereby transmit the torque. The decelerating-side tooth surface 11a is formed as follows. That is, the decelerating-side tooth surface 11a protrudes toward a corresponding one of the teeth 10 of the drive gear 8 and has a circular arc curvature having a curvature radius R2 in the facewidth direction of the corresponding one of the teeth 10. Furthermore, the decelerating-side tooth surface 11a is formed so that the center C2 of the circular arc curvature is located at a deviation Z2 from a plane F2 perpendicular to the facewidth direction of the tooth 11 of the driven gear 9 in the middle of the tooth 11 of the driven gear 9 in the facewidth direction toward an opposite side from a portion of the decelerating-side tooth surface 11a that contacts a corresponding one of the teeth 10 of the drive gear 8 in the facewidth direction at the time when the transmitted torque is maximum.

The curvature radii R1 and R2 of the circular arc curvatures of each pair of decelerating-side tooth surfaces 10a and 11a and the locations (deviations Z1 and Z2) of the centers C1 and C2 of the curvatures are set so that, when torque transmitted between the drive gear 8 and the driven gear 9 is a normal value, the contact length X1 in the facewidth direction between a pair of teeth 10 and 11 becomes a length such that noise can be appropriately suppressed. Furthermore, the curvature radii R1 and R2 and the locations (deviations Z1 and Z2) of the centers C1 and C2 of the curvatures are set so that, when torque transmitted between the drive gear 8 and the driven gear 9 is maximum, the contact area (corresponding to the contact length X2) between a pair of teeth 10 and 11 becomes a size such that load concentration on the contact portions can be appropriately suppressed.

As described above, it is possible to suppress noise when torque transmitted between the meshed drive gear 8 and driven gear 9 is a normal value and to suppress load concentration on contact portions between a pair of teeth 10 and 11 of the respective gears 8 and 9 when the torque is maximum.

(2) By respectively forming the decelerating-side tooth surfaces 10a and the decelerating-side tooth surfaces 11a in the above described shapes, even when the curvature radii R1 and R2 of the circular arc curvatures of those decelerating-side tooth surfaces 10a and 11a are not excessively reduced or the deviations Z1 and Z2 of the centers C1 and C2 of the curvatures from the planes F1 and F2 are not excessively increased, the above advantageous effect (1) may be obtained. Thus, although the above advantageous effect may be obtained, it is possible to suppress an excessive reduction in the curvature radii R1 and R2 or an excessive increase in the deviations Z1 and Z2. This suppresses the extreme circular arc curvatures of the decelerating-side tooth surfaces 10a and 11a in terms of the curvature radii R1 and R2 or the locations of the centers C1 and C2 of the curvatures.
(3) The decelerating-side tooth surfaces 10a are formed in such a manner that the machining portions 32 of the machining tool 31 used to precisely machine the decelerating-side tooth surfaces 10a are engaged with the roughly machined teeth 22 provided for the raw material 21 for forming the drive gear 8 and then the raw material 21 is rotated in this state to thereby precisely machine the tooth surfaces of the teeth 22 of the raw material 21 using the machining portions 32 of the machining tool 31. Then, the inner surface 32a of each machining portion 32 of the machining tool 31, that is, a portion that precisely machines the decelerating-side tooth surface 10a, has an inner shape corresponding to the decelerating-side tooth surface 10a.

On the other hand, the decelerating-side tooth surfaces 11a are formed in such a manner that the machining portions 52 of the machining tool 51 used to precisely machine the decelerating-side tooth surfaces 11a are engaged with the roughly machined teeth 42 provided for the raw material 41 for forming the driven gear 9 and the raw material 41 is rotated in this state to thereby precisely machine the tooth surfaces of the raw material 41 using the machining portions 52 of the machining tool 51. Then, the inner surface 52a of each machining portion 52 of the machining tool 51, that is, a portion that precisely machines the decelerating-side tooth surface 11a, has an inner shape corresponding to the decelerating-side tooth surface 11a.

By forming the decelerating-side tooth surfaces 10a and 11a through the above precise machining, those decelerating-side tooth surfaces 10a and 11a may be framed in appropriate shapes. In addition, as described in the above (2), this suppresses the extreme circular arc curvatures of the decelerating-side tooth surfaces 10a and 11a in terms of the curvature radii R1 and R2 or the locations of the centers C1 and C2 of the curvatures. Therefore, the extreme inner shapes of the machining portions 32 and 52 of the respective machining tools 31 and 51 used in the precise machining are also suppressed in terms of the curvature radii or the locations of the centers of the curvatures. Thus, it is possible to suppress an increase in the degree of difficulty in precisely machining the decelerating-side tooth surfaces 10a and 11a using the machining tools 31 and 51.

(4) The drive gear 8 and driven gear 9 of the gear mechanism 7 function as a final reduction gear in the drive train of the automobile equipped with the manual transmission 3. In the automobile equipped with the above transmission 3, excessive downshift may be performed because of driver's misoperation. In this case, torque transmitted between the drive gear 8 and the driven gear 9 that serve as the final reduction gear is maximum, and the maximum value of the torque is extremely large. Therefore, if the contact area between a pair of teeth 10 and 11 at the meshed portions of the drive gear 8 and driven gear 9 is small, load concentration easily occurs on the contact portions of the pair of teeth 10 and 11 when excessive downshift is performed because of driver's misoperation. Thus, in order to suppress such load concentration, when the decelerating-side tooth surfaces 10a and 11a are formed as described in the above (1), the advantageous effect (1) that may be obtained accordingly is remarkable.

Note that the above embodiment may be, for example, modified into the following alternative embodiments.

One of each decelerating-side tooth surface 10a of the drive gear 8 and each decelerating-side tooth surface 11a of the driven gear 9 may be formed as in the case of the related art.

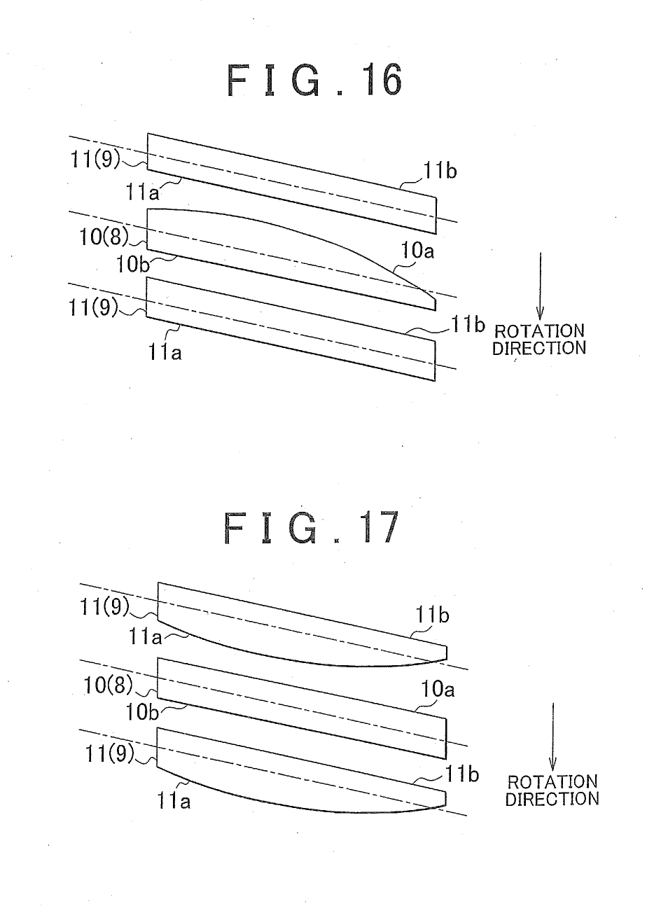

For example, it is conceivable that, as shown in FIG. 16, each decelerating-side tooth surface 10a of the drive gear 8 is formed in a shape according to the aspect of the invention and each decelerating-side tooth surface 11a is formed in a tooth surface shape according to the related art. In this case, the drive gear 8 functions as a first gear according to the aspect of the invention, and the driven gear 9 functions as a second gear according to the aspect of the invention.

In addition, it is also applicable that, as shown in FIG. 17, each decelerating-side tooth surface 10a of the drive gear 8 is formed in a shape according to the related art and each decelerating-side tooth surface 11a of the driven gear 9 is formed in a shape according to the aspect of the invention. In this case, the drive gear 8 functions as a second gear according to the aspect of the invention, and the driven gear 9 functions as a first gear according to the aspect of the invention.

The aspect of the invention is embodied as the gear mechanism 7 that includes the drive gear 8 and the driven gear 9 that serve as a final reduction gear in the drive train of an automobile; however, the aspect of the invention may be embodied as another gear mechanism in the drive train.

The transmission 3 equipped for the automobile may be an automatic transmission.

The teeth 10 of the drive gear 8 and the teeth 11 of the driven gear 9 may be spur teeth.

The aspect of the invention may be applied to a gear mechanism in which bevel gears are used as a first gear and a second gear.

The gear mechanism according to the aspect of the invention may be provided for an FR automobile that drivers rear wheels with an engine mounted at the front of the body, an MR automobile that drives rear wheels with an engine mounted in the middle of the body, an RR automobile that drives rear wheels with an engine mounted at the rear of the body, or the like.

The gear mechanism according to the aspect of the invention may be used in torque transmission, other than the drive train of a vehicle such as an automobile.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1.-7. (canceled)

8. A gear mechanism that includes a first gear and a second gear meshed with each other to transmit torque, wherein a decelerating-side tooth surface that contacts a corresponding one of teeth of the second gear to transmit the torque during deceleration is formed on one side of each tooth of the first gear in a rotation direction of the first gear, and an accelerating-side tooth surface that contacts a corresponding one of the teeth of the second gear to transmit the torque during acceleration is formed on an opposite side of each tooth of the first gear, other than the one side, in the rotation direction of the first gear, wherein:
one of the decelerating-side tooth surface and the accelerating-side tooth surface of each tooth of the first gear protrudes toward the corresponding one of the teeth of the second gear and has a circular arc curvature with respect to a facewidth direction of the corresponding one of the teeth of the second gear, and a center of the circular arc curvature is located apart in a facewidth direction of the tooth of the first gear from a plane perpendicular to the facewidth direction of the tooth of the first gear in a middle of the tooth of the first gear in the facewidth direction.

9. The gear mechanism according to claim 8, wherein
a decelerating-side tooth surface that contacts a corresponding one of the teeth of the first gear to transmit torque during deceleration is formed on one side of each tooth of the second gear in a rotation direction of the second gear, and an accelerating-side tooth surface that contacts a corresponding one of the teeth of the first gear to transmit torque during acceleration is formed on an opposite side of each tooth of the second gear, other than the one side, in the rotation direction of the second gear, and
one of the decelerating-side tooth surface and accelerating-side tooth surface of each tooth of the second gear, which contacts the circular arc tooth surface of the corresponding one of the teeth of the first gear to transmit torque, protrudes toward the corresponding one of the teeth of the first gear and has a circular arc curvature with respect to a facewidth direction of the corresponding one of the teeth of the first gear, and a center of the circular arc curvature is located apart in a facewidth direction of the tooth of the second gear from a plane perpendicular to the facewidth direction of the tooth of the second gear in a middle of the tooth of the second gear in the facewidth direction.

10. The gear mechanism according to claim 9, wherein
a contact length between each tooth of the first gear and a corresponding one of the teeth of the second gear is set to a length such that noise due to contact between each pair of teeth can be appropriately suppressed when torque transmitted between the first gear and the second gear is a normal value.

11. The gear mechanism according to claim 9, wherein
a contact area between each tooth of the first gear and a corresponding one of the teeth of the second gear is set to a size such that load concentration on contact portions of each pair of teeth can be appropriately suppressed when torque transmitted between the first gear and the second gear is a maximum value.

12. The gear mechanism according to claim 8, wherein the first gear and the second gear serve as a final reduction gear in a drive train of a vehicle equipped with a manual transmission.

13. A method for manufacturing a gear mechanism according to claim 8, wherein
the first gear and the second gear each are formed in such a manner that machining portions of a machining tool used to precisely machine tooth surfaces of roughly machined teeth are engaged with the roughly machined teeth provided for a raw material for forming the first gear or the second gear and then the raw material is rotated in this state to thereby precisely machine tooth surfaces of teeth of the raw material using the machining portions of the machining tool, and
one of the decelerating-side tooth surface and accelerating-side tooth surface of each tooth of the first gear, having the circular arc tooth surface, is formed in such a manner that, when the first gear is formed, an inner shape of a portion of each machining portion of the machining tool, which precisely machines the tooth surface into a circular arc shape, is formed in a shape corresponding to the circular arc tooth surface.

14. The method of manufacturing a gear mechanism according to claim 13, wherein
one of the decelerating-side tooth surface and accelerating-side tooth surface of each tooth of the second gear, which contacts the corresponding one of the teeth of the first gear to transmit torque, is formed in such a manner that, when the second gear is formed, an inner shape of a portion of each machining portion of the machining tool, which precisely machines the tooth surface of each tooth of the second gear into a circular arc shape, is formed in a shape corresponding to the circular arc tooth surface.
